(19) United States
(12) Patent Application Publication
(10) Pub. No.: US 2011/0199026 A1
(43) Pub. Date: Aug. 18, 2011

(54) METHOD OF CHARGING AN ENERGY STORAGE DEVICE

(76) Inventors: Earl David Forrest, Asheboro, NC (US); Jian Xu, Windsor (CA)

(21) Appl. No.: 12/705,656

(22) Filed: Feb. 15, 2010

(51) Int. Cl. H05B 37/02; H02J 7/00

(52) U.S. Cl. 315/362; 320/138; 320/101; 320/103

(57) ABSTRACT

A system for charging an energy storage device includes an energy harvester operable to harvest energy from environmental conditions, and to charge an energy storage device at a first rate using the harvested energy. A charging input port detachably receives a secondary energy source. The secondary energy source is operable to charge the energy storage device at a second rate that is faster than the first rate. A sensing module is operable to sense a condition and to transmit a wireless signal indicating an occurrence of the condition.

### BACKGROUND

This disclosure relates to energy storage devices, and more particularly to a system for charging an energy storage device.

Energy harvesters have been used to harvest energy from environmental conditions. However, depending on the type of energy harvester used and the environment into which the energy harvester is placed, an amount of time required for the energy harvester to reach an operational charge may be unpredictable.

### SUMMARY

A system for charging an energy storage device includes an energy harvester operable to harvest energy from environmental conditions, and to charge an energy storage device at a first rate using the harvested energy. A charging input port detachably receives a secondary energy source. The secondary energy source is operable to charge the energy storage device at a second rate that is faster than the first rate. A sensing module is operable to sense a condition and to transmit a wireless signal indicating an occurrence of the condition.

A method of charging an energy storage device charges an energy storage device at a first rate using an energy harvester, wherein the energy harvester harvests energy from environmental conditions. A secondary energy source is detachably received into a charging input port. The energy storage device is charged at a second rate that is faster than the first rate using the secondary energy source.

These and other features of the present disclosure can be best understood from the following specification and drawings, the following of which is a brief description.

### BRIEF DESCRIPTION OF THE DRAWINGS

FIG. 1 schematically illustrates a system for charging an energy storage device.

FIG. 2 schematically illustrates a method of charging the energy storage device of FIG. 1.

FIGS. 3a-e schematically illustrate a plurality of example secondary energy sources operable to be used in connection with the system of FIG. 1.

FIG. 4 schematically illustrates the system of FIG. 1 in connection with various lighting control features.

### DETAILED DESCRIPTION

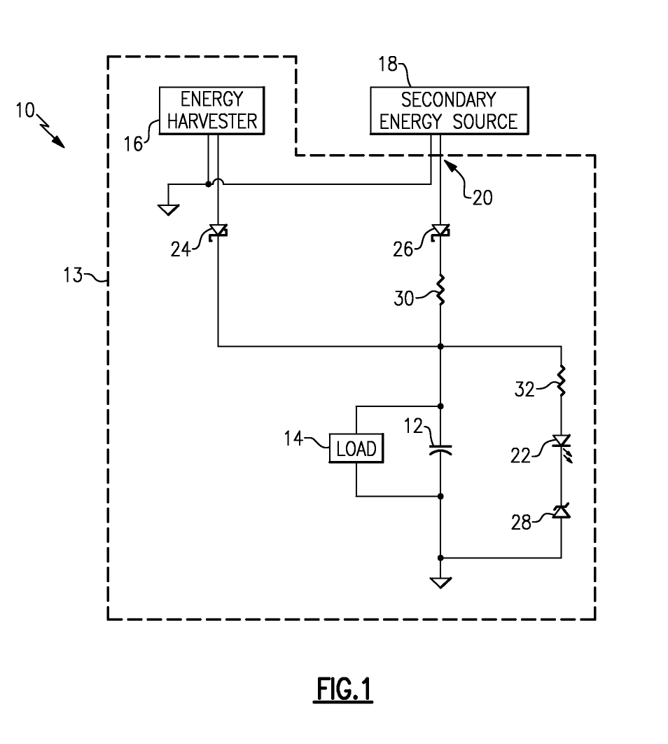

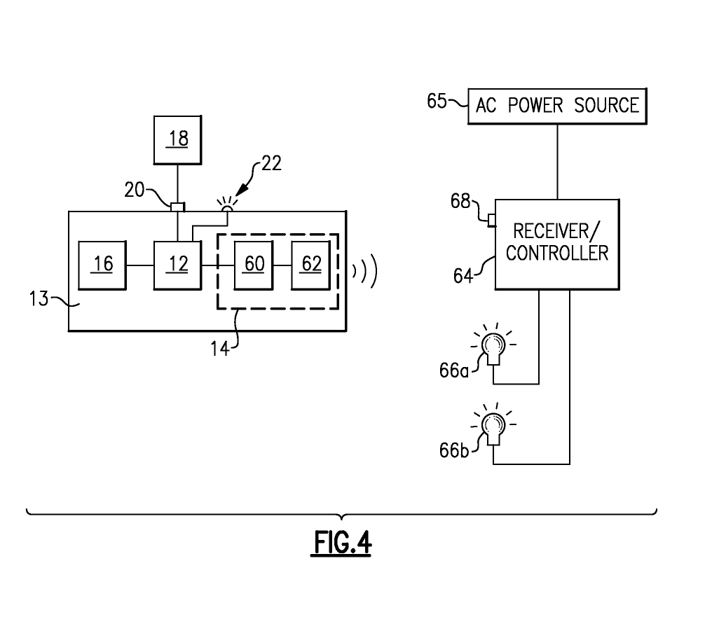

FIG. 1 schematically illustrates a system 10 for charging an energy storage device 12. As shown in FIG. 1, the energy storage device 12 may be part of a remote sensing device 13. The energy storage device 12 powers a load 14. In one example, the load 14 includes a sensor operable to sense a condition and a wireless signal transmitter operable to transmit a wireless signal indicating an occurrence of the condition (see FIG. 4). Of course, other loads could be used (e.g. occupancy motion sensor, a lumen sensor, a CO₂ sensor, water flow sensor).

The remote sensing device 13 includes an energy harvester 16 that is operable to harvest energy from environmental conditions, and that is operable to charge the energy storage device 12 at a first rate using the harvested energy. The energy harvester 16 may include one or more photovoltaic cells, for example. A secondary energy source 18 may be detachably received into the device 13 through a charging port 20. The secondary energy source is configured to charge the energy storage device 12 at a second rate that is faster than the first rate.

The remote sensing device 13 is operable to harvest its own energy using energy harvester 16, and therefore may be self-sustaining such that power required to operate the load 14 may be obtained from energy harvested by the energy harvester 16. However, in some conditions it may be desirable to accelerate charging of the energy storage device 12. For example, if the energy storage device 12 is in an uncharged or a discharged state, a technician may wish to configure the remote sensing device 13, or may wish to perform diagnostic testing on the device 13 and may not wish to wait while the energy harvester 16 charges the energy storage device 12, which depending on the size of the energy storage device 12, and depending on the type and location of energy harvester 16 used, could possibly take an unacceptably long time (e.g. several minutes to several hours).

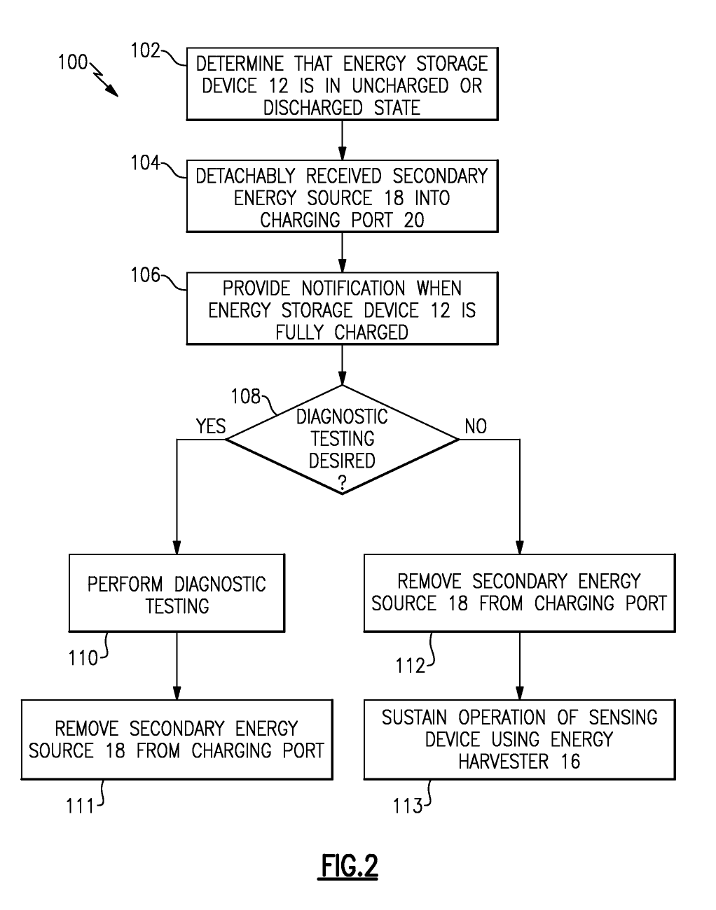

FIG. 2 schematically illustrates a method 100 of charging the energy storage device 12. In step 102 a determination is made that the energy storage device 12 is in an uncharged state (e.g. the remote sensing device 13 has just been installed with energy storage device 12 in an uncharged state) or the energy storage device 12 is in a discharged state (e.g. energy harvester 16 has been unable to sufficiently charge energy storage device 12 in a timely manner). The secondary energy source 18 is detachably received into the charging port 20 to charge the energy storage device 12 (step 104). When the energy storage device 12 is fully charged, a notification is provided (step 106). In the example of FIG. 1, a light-emitting diode (“LED”) 22 emits light upon a full charging. However, the notification need not include light, and could include sound instead of light, or could include sound in addition to light, for example.

A decision is made as to whether diagnostic testing is desired (step 108). If diagnostic testing is desired, then diagnostic testing may be performed on or using the remote sensing device 13 (step 110), and the secondary energy source 18 may be removed from the charging port 20 (step 111). If the steps 110-111 are performed in this order, the energy harvester 16 can maintain a full charge throughout the diagnostic testing, and one could locate the diagnostic circuitry in a secondary charge circuit (e.g. inside the secondary energy source) to minimize the production cost of the remote sensing device 13. Of course, it is also possible that the secondary energy source 18 may be removed prior to performing diagnostic testing, such that step 111 is performed before step 112.

If no diagnostic testing is desired (step 108), the secondary energy source 18 is removed from charting port 22 (step 112) and the energy harvester 16 may be used to sustain operation of the remote sensing device 13 (step 113).

The energy storage device 12 may include a capacitor, a super capacitor or a rechargeable battery, for example. A super capacitor may have a capacitance on the order of 1-10 farads. Of course, other energy storage devices and other energy storage capacities would be possible. As discussed above, an amount of time that it would take to charge the energy storage device 12 would vary in relation to a capacity of the energy storage device 12 and depending on the type and location of the energy harvester 16, possibly taking minutes or many hours. With such charging times, the benefit of the secondary energy source 18 is apparent, as it would enable a technician to perform step 110 or to allow step 112 to occur much sooner than would otherwise be possible if the technician had to wait for the energy storage device 12 to reach a full charge using only the energy harvester 16.

Referring again to FIG. 1, each of the energy harvester 16 and the secondary energy source 18 are separated from the energy storage device 12 by a diode 24, 26. The diodes 24, 26 prevent backcharging such that current does not flow from the energy storage device 12 back into either of the energy harvester 16 or secondary energy source 18. In one example, the diodes 24, 26 are Schottky diodes. Of course, other types of components or circuits could be used to prevent backcharging.

A diode 28 provides an overvoltage protection for the energy storage device 12 by permitting a flow of current to ground if an amount of voltage from the energy harvester 16 or secondary energy source 18 exceeds a threshold. The diode 28 also determines a voltage at which current flows through LED 22 to provide a “full charge” notification. In one example the diode 28 is a Zener diode. Of course, other types of components or circuits could be used. The remote storage device 13 also includes current limiting resistors 30, 32 that limit current to avoid damage to circuit components, such as the LED 22.

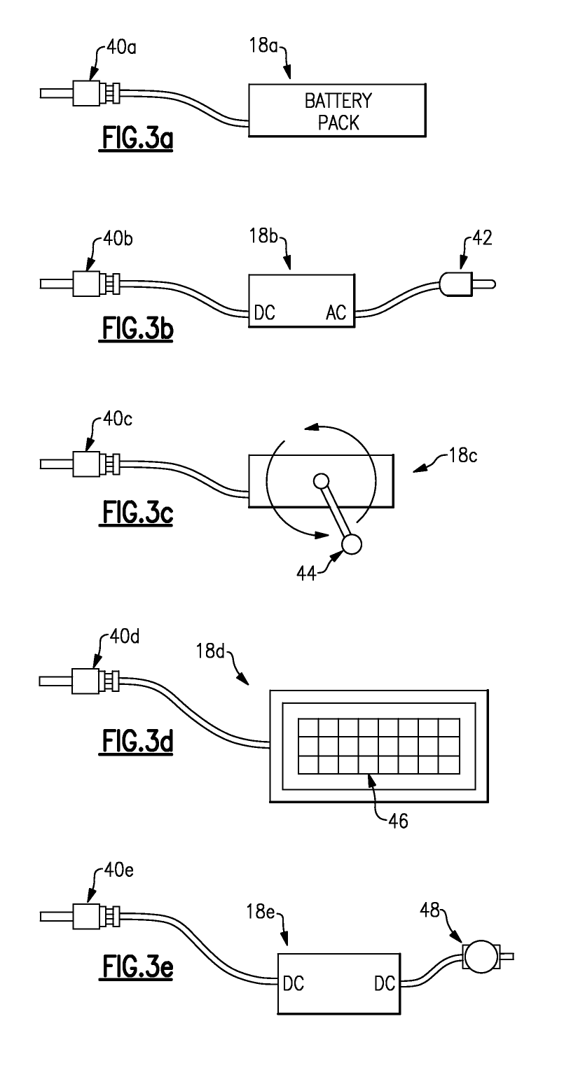

FIGS. 3a-e schematically illustrate a plurality of example secondary energy sources 18, each including an extension 40a-e that may be detachably received into the charging port 20. FIG. 3a schematically illustrates an example battery pack power source 18a that acts as a secondary energy source. The battery pack 18a includes one or more batteries. FIG. 3b schematically illustrates an example AC/DC converter power source 18b that includes an extension 42 to be received into an AC power source, such as an AC receptacle, or even a port 68 on a controller 64 connected to an AC power source 65 (see FIG. 4), for example. The AC/DC converter converts the AC received at extension 42 into DC that passes through the extension 40b into charging port 20.

FIG. 3c schematically illustrates an example hand crank generator power source 18c which is operable to generate a voltage in response to manual rotation of hand crank 44 in a predefined direction (counterclockwise in the example of FIG. 4c). FIG. 3d schematically illustrates an example photovoltaic panel power source 18d that includes a plurality of photovoltaic cells arranged into a photovoltaic panel 46, the photovoltaic panel 46 being operable to harvest solar energy. FIG. 3e schematically illustrates an example DC/DC converter power source 18e that includes an extension 48 operable to be received into a vehicle power outlet (e.g. lighter socket of automobile). The DC/DC converter 18e may be operable to either simply transmit, or to step up or step down a first DC voltage from extension 48 to a second DC voltage at extension 40e that is received into charging port 20. Although certain example secondary energy sources 18a-e have been illustrated, it is understood that these are only examples, and other secondary energy sources would be possible.

FIG. 4 schematically illustrates the system of FIG. 1 in connection with various lighting control features. As in FIG. 1, the remote sensing device 13 includes an energy harvester 16 that is operable to harvest energy from environmental conditions, and that is operable to charge energy storage device 12 at a first rate. The remote sensing device 13 also includes a secondary energy source 18 that may be detachably received into the remote sensing device 13 through charging port 20 to charge the energy storage device 12 at a second rate that is faster than the first rate. LED 22 is operable to provide a “full charge” notification. The load 14 includes a motion sensor 60 operable to sense motion and a wireless signal transmitter 62 operable to transmit a wireless signal in response to motion being detected.

A receiver/controller 64 receives wireless signals from transmitter 62, and is operable to control lighting sources 66a-b using power from AC power source 65 in response to receiving the wireless signals. In one example, the receiver/controller 64 turns the lighting sources 66 ON in response to the sensor 60 detecting motion, and turns the lighting sources 66 OFF in response to the sensor 60 not detecting motion for a predetermined period of time, in a “AUTO ON/AUTO OFF” configuration. In one example the receiver/controller 64 may act as the secondary energy source 18 if a connector is plugged into charging port 20 on the remote sensing device 13 and charging port 68 on the receiver/controller 64 such that the receiver/controller 64 acts as an AC power source (see FIG. 3b) or actually performs an AC/DC conversion acts as a DC power source.

Although a motion sensor 60 and a wireless signal transmitter have been described as an example load 14, it is understood that other loads would be possible.

Although embodiments have been disclosed, a worker of ordinary skill in this art would recognize that certain modifications would come within the scope of this invention. For that reason, the following claims should be studied to determine the true scope and content of this invention.

What is claimed is:

1. A system for charging an energy storage device, comprising:
an energy harvester operable to harvest energy from environmental conditions and to charge an energy storage device at a first rate using the harvested energy;
a charging input port operable to detachably receive a secondary energy source, the secondary energy source being operable to charge the energy storage device at a second rate that is faster than the first rate; and
a sensing module operable to sense a condition and to transmit a wireless signal indicating an occurrence of the condition.

2. The sensing device of claim 1, wherein the sensing module is powered by the energy storage device, by the secondary energy source, or by a combination of the energy storage device and the secondary energy source.

3. The sensing device of claim 1, wherein the energy storage device is a capacitor, and wherein the secondary energy source charges the capacitor from an uncharged or discharged state, and wherein the energy harvester maintains a charge in the capacitor to sustain operation of the sensing module.

4. The sensing device of claim 1, wherein the energy storage device is a super capacitor or a rechargeable battery.

5. The sensing device of claim 1, wherein the secondary power source is a battery pack including one or more batteries.

6. The sensing device of claim 1, wherein the secondary power source is a hand crank generator.

7. The sensing device of claim 1, wherein the secondary power source is a photovoltaic panel including a plurality of photovoltaic cells.

8. The sensing device of claim 1, wherein the secondary power source is an AC to DC converter operable to convert an AC voltage from an AC power source to a DC voltage.

9. The sensing device of claim 1, wherein the secondary power source is a DC to DC converter operable to be received in the charging input port and operable to be received in a vehicle power socket, the DC to DC converter converting a first DC voltage from the vehicle power socket to a second DC voltage.

10. The sensing device of claim 1, including:
a notification device connected in parallel to the energy storage device, the notification device providing a notification in response to the energy storage device reaching a full charge.

11. The sensing device of claim 10, wherein the notification device includes a light emitting diode.

12. The sensing device of claim 10, including:
a zener diode, a cathode of the zener diode being connected to the notification device, an anode of the zener diode being connected to a node that is connected to the energy storage device and ground, the zener diode controlling a voltage at which the notification device turns ON and providing an overvoltage protection for the notification device.

13. A method of charging an energy storage device, comprising:
charging an energy storage device at a first rate using an energy harvester, the energy harvester harvesting energy from environmental conditions;
detachably receiving a secondary energy source into a charging input port;
charging the energy storage device at a second rate that is faster than the first rate using the secondary energy source.

14. The method of claim 13, including:
powering a load with energy stored in the energy storage device, with energy received directly from the secondary energy source, or with both.

15. The method of claim 13, wherein said charging an energy storage device at a second rate provides an initial charge to the energy storage device to power a load, and said charging an energy storage device at a first rate using an energy harvester is continuously performed to maintain power to the load.

16. The method of claim 13, wherein the load includes a motion sensor and a wireless transmitter, the wireless transmitter transmitting a wireless signal in response to the motion sensor detecting motion.

17. The method of claim 13, wherein the secondary energy source includes at least one of a battery pack, an AC/DC converter, a DC/DC converter operable to plug into a vehicle power outlet, a hand crank generator, or a photovoltaic panel.

18. The method of claim 13, wherein the energy storage device includes at least one of a capacitor, a super capacitor or a rechargeable battery.

19. A lighting control system, comprising:
an energy harvester operable to harvest energy from environmental conditions, and to charge an energy storage device at a first rate using the harvested energy;
a charging input port operable to detachably receive a secondary energy source, the secondary energy source being operable to charge the energy storage device at a second rate that is faster than the first rate;
a sensor powered by the energy storage device, powered by the secondary energy source, or powered by a combination of the energy storage device and the secondary energy source, the sensor being operable to detect motion;
a wireless transmitter operable to transmit a wireless signal in response to the sensor detecting motion; and
a lighting controller remote from the sensor and wireless transmitter, the lighting controller being operable to automatically turn a lighting load ON in response to the sensor detecting motion, and being operable to automatically turn the lighting load OFF in response to the sensor not detecting motion for a predetermined period of time.

20. The system of claim 19, wherein the secondary energy source includes at least one of a battery pack, an AC/DC converter, a DC/DC converter operable to plug into a vehicle power outlet, a hand crank generator, or a photovoltaic panel.
